(19) United States
(12) Patent Application Publication
(10) Pub. No.: US 2016/0203801 A1
(43) Pub. Date: Jul. 14, 2016

(54) LOW CAPACITANCE DISPLAY ADDRESS SELECTOR ARCHITECTURE

(71) Applicant: Pixtronix, Inc., San Diego, CA (US)

(72) Inventors: Wilhelmus Adrianus De Groot, Palo Alto, CA (US); Jasper Lodewyk Steyn, Campbell, CA (US); Elif Selin Mungan, Lafayette, IN (US)

(21) Appl. No.: 14/592,784

(22) Filed: Jan. 8, 2015

(51) Int. Cl. G09G 5/395

(52) U.S. Cl. CPC G09G 5/395; G09G 2310/0202; G09G 2360/12; G09G 2310/0262

(57) ABSTRACT

This disclosure provides display-related systems, methods, and apparatus. A display apparatus can include an array of display elements and an address-selector architecture for addressing and loading data into the array of display elements. The address-selector architecture can include a plurality of bank drive interconnects that can provide write enable voltages. Each of a plurality of scan-line interconnects, where each scan-line interconnect is coupled to one row of display elements, is selectively electrically connected to one bank drive interconnect via a transistor. The scan-line interconnects and their corresponding transistors are grouped into a number of row-banks, where the row-banks can include unequal number of scan-line interconnects. The gate terminals of the transistors in each row-bank are connected to a bank-control interconnect. A bank control interconnect driver provides voltages to the bank-control interconnects for selectively turning the transistors in each bank ON and OFF.

### TECHNICAL FIELD

This disclosure relates to the field of imaging displays, and in particular to circuitry for loading data into imaging displays.

### DESCRIPTION OF THE RELATED TECHNOLOGY

Display devices can include a display area having an array of pixels arranged in rows and columns. Display devices also can include a controller, which receives image data associated with an image to be displayed using the array of pixels. The received image data can include, for example, light intensity values associated with each pixel within the array of pixels. The controller can utilize an address selector architecture for loading the appropriate light intensity values in each pixel within the array of pixels.

### SUMMARY

The systems, methods and devices of this disclosure each have several innovative aspects, no single one of which is solely responsible for the desirable attributes disclosed herein.

One innovative aspect of the subject matter described in this disclosure can be implemented in an apparatus including an array of display elements arranged in rows and columns and a plurality of scan-line interconnects arranged in row-banks. Each of the plurality of scan-line interconnects is coupled to one row of display elements. The apparatus further includes a plurality of bank drive interconnects. Each of the plurality of bank drive interconnects is capable of carrying a write enable voltage to one scan-line interconnect in at least one row-bank. The apparatus also includes a write enable voltage driver coupled to the plurality of bank drive interconnects and capable of providing write enable voltages to each of the plurality of bank drive interconnects. The apparatus further includes a plurality of row-enable transistors. One of the source and drain terminals of each of the plurality of row-enable transistors is coupled to one of the plurality of scan-line interconnects. The other terminal is coupled to one of the plurality of bank drive interconnects. The apparatus also includes a plurality of bank control interconnects. Each of the plurality of bank control interconnects is coupled to the gate terminals of the row-enable transistors associated with scan-line interconnects of a corresponding row-bank. The apparatus also includes a bank control interconnect driver coupled to the plurality of bank control interconnects and capable of providing control voltages to each of the plurality of bank control interconnects. The number of scan-line interconnects in a first row-bank located a first distance from the write-enable voltage driver is greater than a number of scan-line interconnects in a second row-bank of scan-line interconnects located a second distance, farther from the write-enable voltage driver.

In some implementations, the number of scan-line interconnects in each row-bank is based in part on a load parameter associated with a bank control interconnect coupled to the row-enable transistors associated with the respective row-banks. In some implementations, the size of a first of the row-enable transistors located a first distance from the bank control interconnect driver is greater than the size of a second of the row-enable transistors located a second distance, nearer from the bank control interconnect driver. In some implementations, the sizes of the plurality of row-enable transistors are substantially the same. In some implementations, the row-enable transistor located farthest from the write-enable voltage driver is coupled to a bank drive interconnect that is coupled to a fewer number of other row-enable transistors than at least one other bank drive interconnect.

In some implementations, propagation delays of control voltages provided by the bank control interconnect driver over the plurality of bank control interconnects are substantially equal. In some implementations, the number of bank drive interconnects is equal to the number of row-enable transistors in the largest row-bank of scan-line interconnects. In some implementations, each of the bank drive interconnects terminates at the farthest row-enable transistor coupled to the bank drive interconnect. In some implementations, the array of display elements are located within a display area on a substrate, and where the plurality of bank drive interconnects and the plurality of bank control interconnects are located on the substrate outside of the display area. In some implementations, RC time constants associated with the plurality of row-control interconnect are substantially equal.

In some implementations, the apparatus further includes a display, a processor capable of communicating with the display, the processor being capable of processing image data, and a memory device capable of communicating with the processor. In some implementations, the apparatus further includes a driver circuit capable of sending at least one signal to the display, and a controller capable of sending at least a portion of the image data to the driver circuit. In some implementations, the apparatus further includes an image source module capable of sending the image data to the processor, where the image source module includes at least one of a receiver, transceiver, and transmitter. In some implementations, the apparatus further includes an input device capable of receiving input data and communicating the input data to the processor.

Another innovative aspect of the subject matter described in this disclosure can be implemented in an apparatus including an array of display elements arranged in rows and columns and a plurality of scan-line interconnects arranged in row-banks. Each of the plurality of scan-line interconnects is coupled to one row of display elements from the array of display elements. The apparatus further includes a plurality of bank drive interconnects. Each of the plurality of bank drive interconnects is capable of carrying a write enable voltage to one scan-line interconnect in at least one row-bank. The apparatus further includes a write enable voltage driver coupled to the plurality of bank drive interconnects and capable of providing write enable voltages to each of the plurality of bank drive interconnects. The apparatus also includes a plurality of row-enable transistors. One of the source and drain terminals of each of the plurality of row-enable transistors is coupled to one of the plurality of scan-line interconnects. The other of the source and drain terminals of each of the plurality of row-enable transistors is coupled to one of the plurality of bank drive interconnects. The apparatus also includes a plurality of bank control interconnects. Each of the plurality of bank control interconnects is coupled to the gate terminals of the row-enable transistors associated with scan-line interconnects arranged in a corresponding row-bank. The apparatus further includes a bank control interconnect driver coupled to the plurality of bank control interconnects and capable of providing control voltages to each of the plurality of bank control interconnects. The size of a first of the row-enable transistors located a first distance from the bank control interconnect driver is greater than the size of a second of the row-enable transistors located a second distance, nearer from the bank control interconnect driver.

In some implementations, the number of scan-line interconnects in a first row-bank located a first distance from the write-enable voltage driver is greater than a number of scan-line interconnects in a second row-bank of scan-line interconnects located a second distance, greater than the first distance, from the write-enable voltage driver. In some implementations, each of the bank drive interconnects terminates at the farthest row-enable transistor coupled to the bank drive interconnect.

Another innovative aspect of the subject matter described in this disclosure can be implemented in an apparatus including an array of display elements arranged in rows and columns and a plurality of scan-line interconnects arranged in row-banks. Each of the plurality of scan-line interconnects is coupled to one row of display elements from the array of display elements. The apparatus further includes a plurality of bank drive interconnects. Each of the plurality of bank drive interconnects is capable of carrying a write enable voltage to one scan-line interconnect in at least one row-bank. The apparatus also includes a write enable voltage driver coupled to the plurality of bank drive interconnects and capable of providing write enable voltages to each of the plurality of bank drive interconnects. The apparatus additionally includes a plurality of row-enable transistors. One of the source and drain terminals of each of the plurality of row-enable transistors is coupled to one of the plurality of scan-line interconnects. The other of the source and drain terminals of each of the plurality of row-enable transistors is coupled to one of the plurality of bank drive interconnects. The apparatus also includes a plurality of bank control interconnects. Each of the plurality of bank control interconnects is coupled to the gate terminals of the row-enable transistors associated with the scan-line interconnects of a corresponding row-bank. The apparatus further includes a bank control interconnect driver coupled to the plurality of bank control interconnects and capable of providing control voltages to each of the plurality of bank control interconnects. Each of the bank drive interconnects terminates at the farthest row-enable transistor coupled to the bank drive interconnect.

In some implementations, the number of scan-line interconnects in a first row-bank located a first distance from the write-enable voltage driver is greater than a number of scan-line interconnects in a second row-bank of scan-line interconnects located a second distance, greater than the first distance, from the write-enable voltage driver. In some implementations, the size of a first of the row-enable transistors located a first distance from the bank control interconnect driver is greater than the size of a second of the row-enable transistors located a second distance from the bank control interconnect driver, where the first distance is greater than the second distance.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1A shows a schematic diagram of an example direct-view microelectromechanical systems (MEMS) based display apparatus.

FIG. 1B shows a block diagram of an example host device.

FIGS. 2A and 2B show views of an example dual actuator shutter assembly.

FIG. 3 shows a block diagram of an example display apparatus.

FIG. 4 shows an example address selector architecture.

FIG. 5 shows an example timing diagram for various signals output by a scan-line driver shown in FIG. 4 during an addressing period.

FIGS. 6 and 7 show additional example address selector architectures.

FIGS. 8A and 8B show system block diagrams of an example display device that includes a plurality of display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that is capable of displaying an image, whether in motion (such as video) or stationary (such as still images), and whether textual, graphical or pictorial. The concepts and examples provided in this disclosure may be applicable to a variety of displays, such as liquid crystal displays (LCDs), organic light-emitting diode (OLED) displays, field emission displays, and electromechanical systems (EMS) and microelectromechanical (MEMS)-based displays, in addition to displays incorporating features from one or more display technologies.

The described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, wearable devices, clocks, calculators, television monitors, flat panel displays, electronic reading devices (such as e-readers), computer monitors, auto displays (such as odometer and speedometer displays), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players. CD players, VCRs, radios, portable memory chips, washers, dryers, washer/dryers, parking meters, packaging (such as in electromechanical systems (EMS) applications including microelectromechanical systems (MEMS) applications, in addition to non-EMS applications), aesthetic structures (such as display of images on a piece of jewelry or clothing) and a variety of EMS devices.

The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

An apparatus for displaying an image can include an array of display elements. The display apparatus also can include an address selector architecture for addressing and loading data into the array of display elements. In some implementations, the address selector architecture can include a plurality of bank drive interconnects that can carry write-enable voltages. The display apparatus also includes a plurality of scan-line interconnects. Each scan-line interconnect is coupled to one row of the array of display elements, and is selectively electrically connected to one of the bank drive interconnects via a transistor switch. The scan-line interconnects and their corresponding transistor switches are grouped into a number of row-banks. The gate terminals of the transistor switches in each row-bank are coupled to a bank control interconnect. The bank control interconnects for all the row-banks are driven by a bank control interconnect driver, which provides voltages for selectively turning the transistor switches in each bank ON and OFF. To provide a write enable voltage to a given scan-line interconnect, the address selector architecture turns ON the transistor switches in the row-bank to which the scan-line interconnect belongs and provides the write enable signal to the bank drive interconnect electrically connected to the scan-line interconnect.

In some implementations, the number of scan-line interconnects or the number of transistor switches within a row-bank can be based on a distance of the bank from the bank control interconnect driver. In some implementations, the farther the row-bank is from the bank control interconnect driver, the number of scan-line interconnects belonging to the row-bank is smaller. In some implementations, the bank drive interconnects are terminated at the farthest one of the transistor switches coupled to the bank drive interconnect. In some implementations, the scan-line interconnect farthest from a write enable voltage driver, which provides the write enable voltage, is electrically connected to a bank drive interconnect that is electrically connected to fewer other scan-line interconnects than at least one other bank drive interconnect.

Particular implementations of the subject matter described in this disclosure can be implemented to realize one or more of the following potential advantages. Address selector architectures in displays can reduce the number of interconnects needed to address the display elements in the display apparatus. A reduction in the number of interconnects allows a reduction in the size of a bezel that surrounds a display area on the display apparatus and is used to accommodate the interconnects of the display apparatus. A reduction in the number of interconnects also reduces the pin-count needed for an integrated circuit that drives the interconnects. The address selector architectures disclosed herein improve upon existing address selector architectures by balancing loads on the interconnects in the architecture. This load balancing reduces the longest propagation delay of signals transmitted over these interconnects, thereby reducing the overall addressing time of the display apparatus. In some implementations, this reduction in addressing time can result in a display incorporating the address selector architectures disclosed herein to operate using less power than displays with other address selector architectures. For example, with the time saved from the reduced addressing time, the display apparatus can display images using lower light source illumination intensities. In some implementations, the reduced addressing time can allow for improved image quality relative to displays incorporating other address selector architectures. For example, the time savings may allow for sufficient time to display additional subframes per image frame.

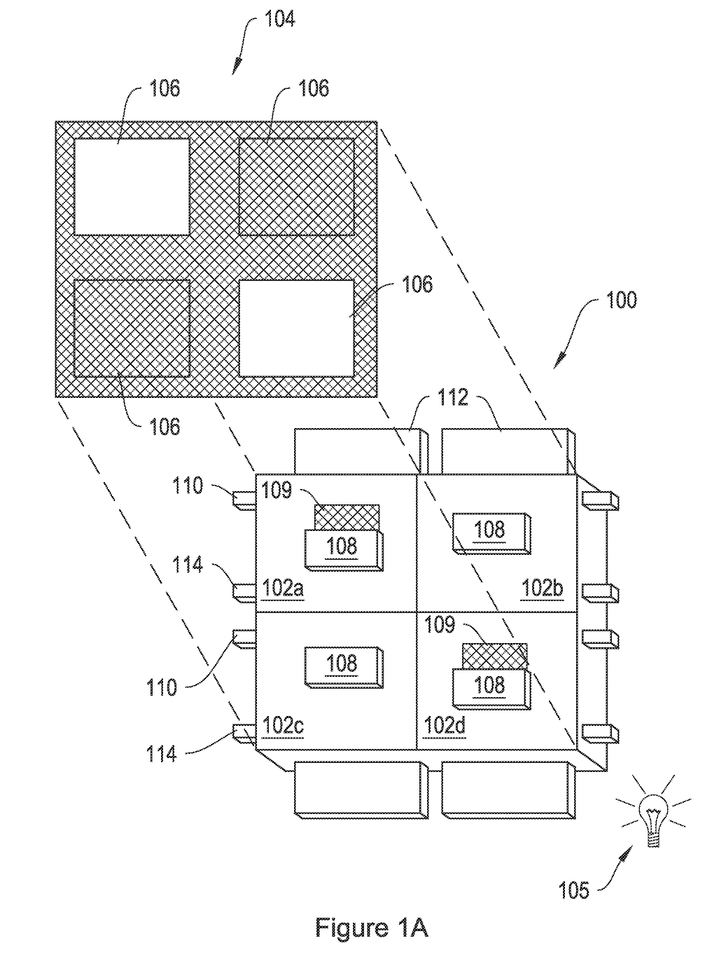

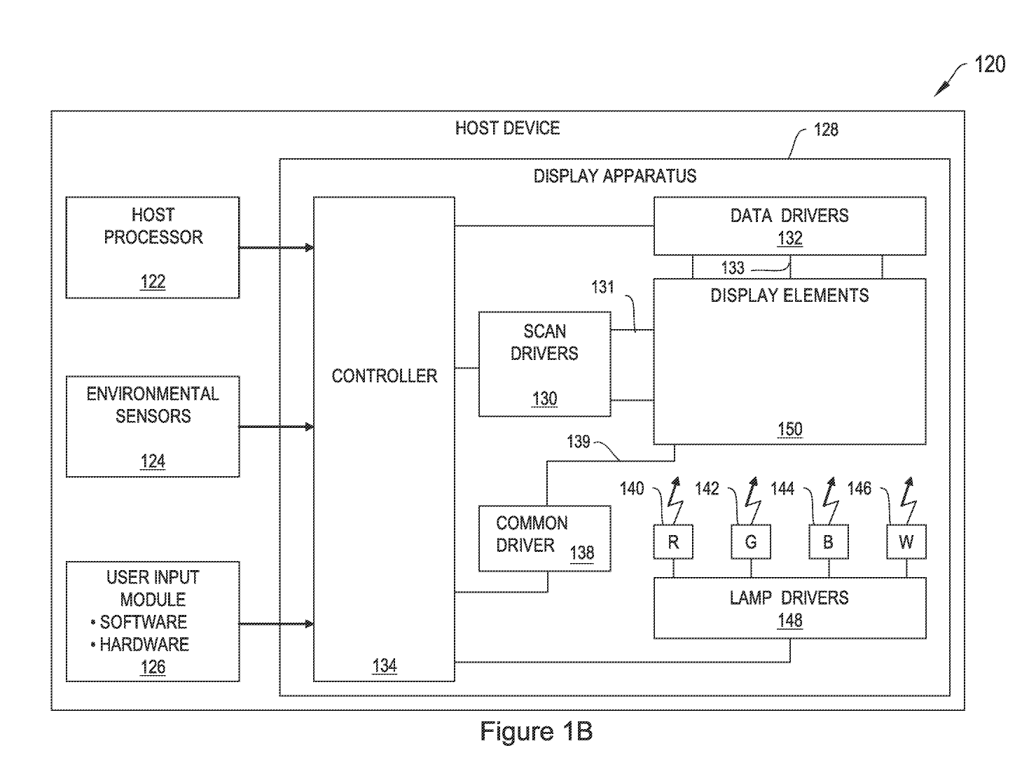

FIG. 1A shows a schematic diagram of an example direct-view MEMS-based display apparatus 100. The display apparatus 100 includes a plurality of light modulators 102a-102d (generally light modulators 102) arranged in rows and columns. In the display apparatus 100, the light modulators 102a and 102d are in the open state, allowing light to pass. The light modulators 102b and 102c are in the closed state, obstructing the passage of light. By selectively setting the states of the light modulators 102a-102d, the display apparatus 100 can be utilized to form an image 104 for a backlit display, if illuminated by a lamp or lamps 105. In another implementation, the apparatus 100 may form an image by reflection of ambient light originating from the front of the apparatus. In another implementation, the apparatus 100 may form an image by reflection of light from a lamp or lamps positioned in the front of the display, i.e., by use of a front light.

In some implementations, each light modulator 102 corresponds to a pixel 106 in the image 104. In some other implementations, the display apparatus 100 may utilize a plurality of light modulators to form a pixel 106 in the image 104. For example, the display apparatus 100 may include three color-specific light modulators 102. By selectively opening one or more of the color-specific light modulators 102 corresponding to a particular pixel 106, the display apparatus 100 can generate a color pixel 106 in the image 104. In another example, the display apparatus 100 includes two or more light modulators 102 per pixel 106 to provide a luminance level in an image 104. With respect to an image, a pixel corresponds to the smallest picture element defined by the resolution of image. With respect to structural components of the display apparatus 100, the term pixel refers to the combined mechanical and electrical components utilized to modulate the light that forms a single pixel of the image.

The display apparatus 100 is a direct-view display in that it may not include imaging optics typically found in projection applications. In a projection display, the image formed on the surface of the display apparatus is projected onto a screen or onto a wall. The display apparatus is substantially smaller than the projected image. In a direct view display, the image can be seen by looking directly at the display apparatus, which contains the light modulators and optionally a backlight or front light for enhancing brightness and/or contrast seen on the display.

Direct-view displays may operate in either a transmissive or reflective mode. In a transmissive display, the light modulators filter or selectively block light which originates from a lamp or lamps positioned behind the display. The light from the lamps is optionally injected into a lightguide or backlight so that each pixel can be uniformly illuminated. Transmissive direct-view displays are often built onto transparent substrates to facilitate a sandwich assembly arrangement where one substrate, containing the light modulators, is positioned over the backlight. In some implementations, the transparent substrate can be a glass substrate (sometimes referred to as a glass plate or panel), or a plastic substrate. The glass substrate may be or include, for example, a borosilicate glass, wine glass, fused silica, a soda lime glass, quartz, artificial quartz, Pyrex, or other suitable glass material.

Each light modulator 102 can include a shutter 108 and an aperture 109. To illuminate a pixel 106 in the image 104, the shutter 108 is positioned such that it allows light to pass through the aperture 109. To keep a pixel 106 unlit, the shutter 108 is positioned such that it obstructs the passage of light through the aperture 109. The aperture 109 is defined by an opening patterned through a reflective or light-absorbing material in each light modulator 102.

The display apparatus also includes a control matrix coupled to the substrate and to the light modulators for controlling the movement of the shutters. The control matrix includes a series of electrical interconnects (such as interconnects 110, 112 and 114), including at least one write-enable interconnect 110 (also referred to as a scan line interconnect) per row of pixels, one data interconnect 112 for each column of pixels, and one common interconnect 114 providing a common voltage to all pixels, or at least to pixels from both multiple columns and multiples rows in the display apparatus 100. In response to the application of an appropriate voltage (the write-enabling voltage, V_{WE}), the write-enable interconnect 110 for a given row of pixels prepares the pixels in the row to accept new shutter movement instructions. The data interconnects 112 communicate the new movement instructions in the form of data voltage pulses. The data voltage pulses applied to the data interconnects 112, in some implementations, directly contribute to an electrostatic movement of the shutters. In some other implementations, the data voltage pulses control switches, such as transistors or other non-linear circuit elements that control the application of separate drive voltages, which are typically higher in magnitude than the data voltages, to the light modulators 102. The application of these drive voltages results in the electrostatic driven movement of the shutters 108.

The control matrix also may include, without limitation, circuitry, such as a transistor and a capacitor associated with each shutter assembly. In some implementations, the gate of each transistor can be electrically connected to a scan line interconnect. In some implementations, the source of each transistor can be electrically connected to a corresponding data interconnect. In some implementations, the drain of each transistor may be electrically connected in parallel to an electrode of a corresponding capacitor and to an electrode of a corresponding actuator. In some implementations, the other electrode of the capacitor and the actuator associated with each shutter assembly may be connected to a common or ground potential. In some other implementations, the transistor can be replaced with a semiconducting diode, or a metal-insulator-metal switching element.

FIG. 1B shows a block diagram of an example host device 120 (i.e., cell phone, smart phone, PDA, MP3 player, tablet, e-reader, netbook, notebook, watch, wearable device, laptop, television, or other electronic device). The host device 120 includes a display apparatus 128 (such as the display apparatus 100 shown in FIG. 1A), a host processor 122, environmental sensors 124, a user input module 126, and a power source.

The display apparatus 128 includes a plurality of scan drivers 130 (also referred to as write enabling voltage sources), a plurality of data drivers 132 (also referred to as data voltage sources), a controller 134, common drivers 138, lamps 140-146, lamp drivers 148 and an array of display elements 150, such as the light modulators 102 shown in FIG. 1A. The scan drivers 130 apply write enabling voltages to scan line interconnects 131. The data drivers 132 apply data voltages to the data interconnects 133.

In some implementations of the display apparatus, the data drivers 132 are capable of providing analog data voltages to the array of display elements 150, especially where the luminance level of the image is to be derived in analog fashion. In analog operation, the display elements are designed such that when a range of intermediate voltages is applied through the data interconnects 133, there results a range of intermediate illumination states or luminance levels in the resulting image. In some other implementations, the data drivers 132 are capable of applying a reduced set, such as 2, 3 or 4, of digital voltage levels to the data interconnects 133. In implementations in which the display elements are shutter-based light modulators, such as the light modulators 102 shown in FIG. 1A, these voltage levels are designed to set, in digital fashion, an open state, a closed state, or other discrete state to each of the shutters 108. In some implementations, the drivers are capable of switching between analog and digital modes.

The scan drivers 130 and the data drivers 132 are connected to a digital controller circuit 134 (also referred to as the controller 134). The controller 134 sends data to the data drivers 132 in a mostly serial fashion, organized in sequences, which in some implementations may be predetermined, grouped by rows and by image frames. The data drivers 132 can include series-to-parallel data converters, level-shifting, and for some applications digital-to-analog voltage converters.

The display apparatus optionally includes a set of common drivers 138, also referred to as common voltage sources. In some implementations, the common drivers 138 provide a DC common potential to all display elements within the array 150 of display elements, for instance by supplying voltage to a series of common interconnects 139. In some other implementations, the common drivers 138, following commands from the controller 134, issue voltage pulses or signals to the array of display elements 150, for instance global actuation pulses which are capable of driving and/or initiating simultaneous actuation of all display elements in multiple rows and columns of the array.

Each of the drivers (such as scan drivers 130, data drivers 132 and common drivers 138) for different display functions can be time-synchronized by the controller 134. Timing commands from the controller 134 coordinate the illumination of red, green, blue and white lamps (140, 142, 144 and 146 respectively) via lamp drivers 148, the write-enabling and sequencing of specific rows within the array of display elements 150, the output of voltages from the data drivers 132, and the output of voltages that provide for display element actuation. In some implementations, the lamps are light emitting diodes (LEDs).

The controller 134 determines the sequencing or addressing scheme by which each of the display elements can be re-set to the illumination levels appropriate to a new image 104. New images 104 can be set at periodic intervals. For instance, for video displays, color images or frames of video are refreshed at frequencies ranging from 10 to 300 Hertz (Hz). In some implementations, the setting of an image frame to the array of display elements 150 is synchronized with the illumination of the lamps 140, 142, 144 and 146 such that alternate image frames are illuminated with an alternating series of colors, such as red, green, blue and white. The image frames for each respective color are referred to as color subframes. In this method, referred to as the field sequential color method, if the color subframes are alternated at frequencies in excess of 20 Hz, the human visual system (HVS) will average the alternating frame images into the perception of an image having a broad and continuous range of colors. In some other implementations, the lamps can employ primary colors other than red, green, blue and white. In some implementations, fewer than four, or more than four lamps with primary colors can be employed in the display apparatus 128.

In some implementations, where the display apparatus 128 is designed for the digital switching of shutters, such as the shutters 108 shown in FIG. 1A, between open and closed states, the controller 134 forms an image by the method of time division gray scale. In some other implementations, the display apparatus 128 can provide gray scale through the use of multiple display elements per pixel.

In some implementations, the data for an image state is loaded by the controller 134 to the array of display elements 150 by a sequential addressing of individual rows, also referred to as scan lines. For each row or scan line in the sequence, the scan driver 130 applies a write-enable voltage to the write enable interconnect 131 for that row of the array of display elements 150, and subsequently the data driver 132 supplies data voltages, corresponding to desired shutter states, for each column in the selected row of the array. This addressing process can repeat until data has been loaded for all rows in the array of display elements 150. In some implementations, the sequence of selected rows for data loading is linear, proceeding from top to bottom in the array of display elements 150. In some other implementations, the sequence of selected rows is pseudo-randomized, in order to mitigate potential visual artifacts. And in some other implementations, the sequencing is organized by blocks, where, for a block, the data for a certain fraction of the image is loaded to the array of display elements 150. For example, the sequence can be implemented to address every fifth row of the array of the display elements 150 in sequence.

In some implementations, the addressing process for loading image data to the array of display elements 150 is separated in time from the process of actuating the display elements. In such an implementation, the array of display elements 150 may include data memory elements for each display element, and the control matrix may include a global actuation interconnect for carrying trigger signals, from the common driver 138, to initiate simultaneous actuation of the display elements according to data stored in the memory elements.

In some implementations, the array of display elements 150 and the control matrix that controls the display elements may be arranged in configurations other than rectangular rows and columns. For example, the display elements can be arranged in hexagonal arrays or curvilinear rows and columns.

The host processor 122 generally controls the operations of the host device 120. For example, the host processor 122 may be a general or special purpose processor for controlling a portable electronic device. With respect to the display apparatus 128, included within the host device 120, the host processor 122 outputs image data as well as additional data about the host device 120. Such information may include data from environmental sensors 124, such as ambient light or temperature; information about the host device 120, including, for example, an operating mode of the host or the amount of power remaining in the host device's power source; information about the content of the image data; information about the type of image data; and/or instructions for the display apparatus 128 for use in selecting an imaging mode.

In some implementations, the user input module 126 enables the conveyance of personal preferences of a user to the controller 134, either directly, or via the host processor 122. In some implementations, the user input module 126 is controlled by software in which a user inputs personal preferences, for example, color, contrast, power, brightness, content, and other display settings and parameters preferences. In some other implementations, the user input module 126 is controlled by hardware in which a user inputs personal preferences. In some implementations, the user may input these preferences via voice commands, one or more buttons, switches or dials, or with touch-capability. The plurality of data inputs to the controller 134 direct the controller to provide data to the various drivers 130, 132, 138 and 148 which correspond to optimal imaging characteristics.

The environmental sensor module 124 also can be included as part of the host device 120. The environmental sensor module 124 can be capable of receiving data about the ambient environment, such as temperature and or ambient lighting conditions. The sensor module 124 can be programmed, for example, to distinguish whether the device is operating in an indoor or office environment versus an outdoor environment in bright daylight versus an outdoor environment at nighttime. The sensor module 124 communicates this information to the display controller 134, so that the controller 134 can optimize the viewing conditions in response to the ambient environment.

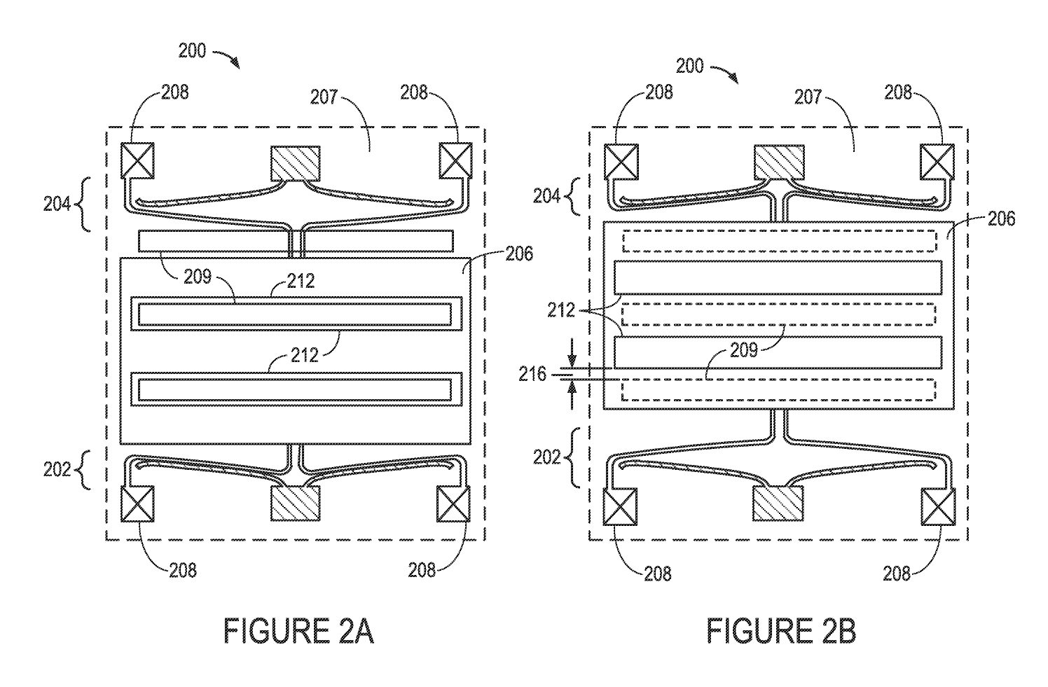

FIGS. 2A and 2B show views of an example dual actuator shutter assembly 200. The dual actuator shutter assembly 200, as depicted in FIG. 2A, is in an open state. FIG. 2B shows the dual actuator shutter assembly 200 in a closed state. The shutter assembly 200 includes actuators 202 and 204 on either side of a shutter 206. Each actuator 202 and 204 is independently controlled. A first actuator, a shutter-open actuator 202, serves to open the shutter 206. A second opposing actuator, the shutter-close actuator 204, serves to close the shutter 206. Each of the actuators 202 and 204 can be implemented as compliant beam electrode actuators. The actuators 202 and 204 open and close the shutter 206 by driving the shutter 206 substantially in a plane parallel to an aperture layer 207 over which the shutter is suspended. The shutter 206 is suspended a short distance over the aperture layer 207 by anchors 208 attached to the actuators 202 and 204. Having the actuators 202 and 204 attach to opposing ends of the shutter 206 along its axis of movement reduces out of plane motion of the shutter 206 and confines the motion substantially to a plane parallel to the substrate (not depicted).

In the depicted implementation, the shutter 206 includes two shutter apertures 212 through which light can pass. The aperture layer 207 includes a set of three apertures 209. In FIG. 2A, the shutter assembly 200 is in the open state and, as such, the shutter-open actuator 202 has been actuated, the shutter-close actuator 204 is in its relaxed position, and the centerlines of the shutter apertures 212 coincide with the centerlines of two of the aperture layer apertures 209. In FIG. 2B, the shutter assembly 200 has been moved to the closed state and, as such, the shutter-open actuator 202 is in its relaxed position, the shutter-close actuator 204 has been actuated, and the light blocking portions of the shutter 206 are now in position to block transmission of light through the apertures 209 (depicted as dotted lines).

Each aperture has at least one edge around its periphery. For example, the rectangular apertures 209 have four edges. In some implementations, in which circular, elliptical, oval, or other curved apertures are formed in the aperture layer 207, each aperture may have a single edge. In some other implementations, the apertures need not be separated or disjointed in the mathematical sense, but instead can be connected. That is to say, while portions or shaped sections of the aperture may maintain a correspondence to each shutter, several of these sections may be connected such that a single continuous perimeter of the aperture is shared by multiple shutters.

In order to allow light with a variety of exit angles to pass through the apertures 212 and 209 in the open state, the width or size of the shutter apertures 212 can be designed to be larger than a corresponding width or size of apertures 209 in the aperture layer 207. In order to effectively block light from escaping in the closed state, the light blocking portions of the shutter 206 can be designed to overlap the edges of the apertures 209. FIG. 2B shows an overlap 216, which in some implementations can be predefined, between the edge of light blocking portions in the shutter 206 and one edge of the aperture 209 formed in the aperture layer 207.

The electrostatic actuators 202 and 204 are designed so that their voltage-displacement behavior provides a bi-stable characteristic to the shutter assembly 200. For each of the shutter-open and shutter-close actuators, there exists a range of voltages below the actuation voltage, which if applied while that actuator is in the closed state (with the shutter being either open or closed), will hold the actuator closed and the shutter in position, even after a drive voltage is applied to the opposing actuator. The minimum voltage needed to maintain a shutter's position against such an opposing force is referred to as a maintenance voltage Vₘ.

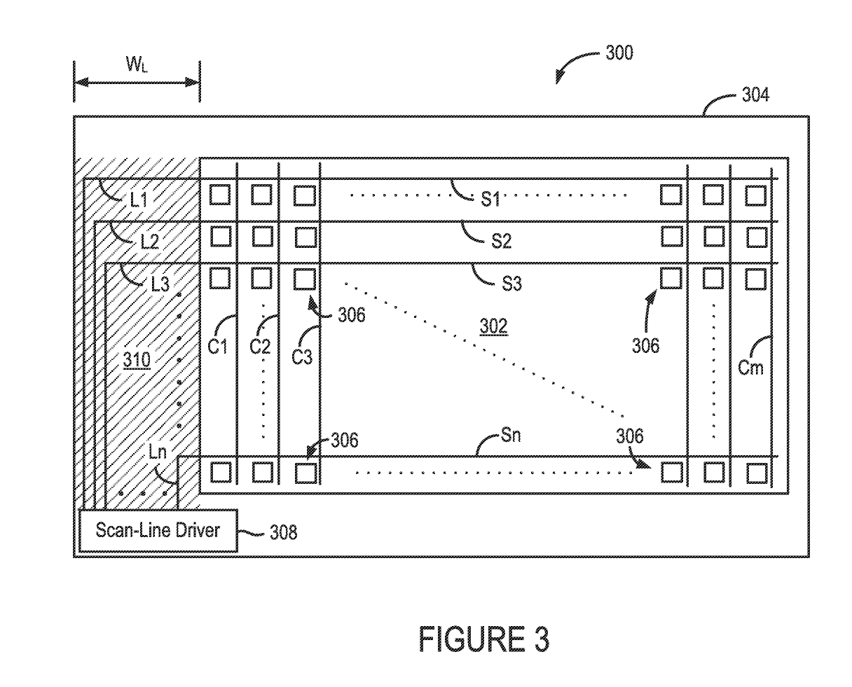

FIG. 3 shows a block diagram of an example display apparatus 300. The display apparatus 300 can be similar to the display apparatus 128 discussed above in relation to FIG. 1B. In particular, the display apparatus 300 shown in FIG. 3 can include a display area 302 formed on a substrate 304, a scan-line driver 308, and scan-line routing interconnects L1-Ln formed over a non-display area 310 along the periphery of the substrate 304. Typically, the area on the substrate 304 outside of the display area 302 and along the periphery of the display area is referred to as “the bezel.” The bezel includes the non-display area 310 on which the scan-line routing interconnects L1-Ln are formed. The display area 302 can be utilized to display images on the display apparatus 300. The display area 302 can include an array of display elements 306 such as liquid crystal or EMS-based light modulators or OLEDs or other similar light emitters. The array of display elements 306 can be similar to the array of display elements 150 discussed above in relation to FIG. 1B. Each display element 306 can include a light modulator, such as the light modulators 102 shown in FIG. 1A and the light modulator 200 shown in FIGS. 2A and 2B. In some implementations, where the display apparatus 300 operates as a transmissive or transflective display, the substrate 304 can be a transparent substrate made of a transparent material such as glass or plastic to allow light from a backlight to pass through and be modulated by the display elements 306. In some other implementations, where the display apparatus 300 operates as a reflective display, the substrate 304 can include non-transparent materials, such as, for example one or more semiconductor materials. A backplane including electronics needed for the operation of the display elements 306 also can be formed on the substrate 304.

The array of display elements 306 are arranged in rows and columns. The display elements 306 in each row are coupled to a common scan-line interconnect associated with the row while the display elements 306 in each column are coupled to a common data-line interconnect associated with the column. For example, as shown in FIG. 3, the display apparatus 302 includes n scan-line interconnects S1-Sn and m data-line interconnects C1-Cm. A scan-line interconnect is utilized for carrying a write-enable signal that enables a row of display elements 306 to accept and store data provided on their respective data-line interconnects. The scan-line interconnects S1-Sn can be formed to extend to the edge of the display area 302 from where they are connected to the scan-line driver 308 via scan-line routing interconnects L1-Ln. The scan-line driver 308 is capable of applying a write-enable voltage to a scan-line interconnect to enable the display elements 306 coupled to that scan-line interconnect to accept and store data voltages received via their respective data-line interconnects. The scan-line driver 308 can be similar to the scan driver 130 discussed above in relation to FIG. 1B. The scan-line driver 308, the scan-line routing interconnects L1-Ln, and the scan-line interconnects S1-Sn can collectively be referred to as an addressing architecture.

In some implementations, the scan-line routing interconnects L1-Ln connecting the scan-line interconnects S1-Sn within the display area 302 to the scan-line driver 308 can be routed on the substrate 304 along the edges of the display area 302. In particular, the scan-line routing interconnects L1-Ln can be formed over a portion 310 of the substrate 304 (shown with a cross-hatched pattern in FIG. 3) along a periphery of the display area 302. One end of each of the n scan-line routing interconnects L1-Ln is coupled to one of the n scan-line interconnects S1-Sn, while the other end is coupled to the scan-line driver 308. The scan-line driver 308 can selectively apply write-enable voltages to each of the scan-line interconnects S1-Sn via the scan-line routing interconnects L-Ln to load data voltages in each of the display elements 302.

For a given size of the substrate 304, a large number of scan-line routing interconnects L1-Ln can limit the area available on the substrate 304 for forming the display area 302. For example, a routing width W_{L} occupied by the scan-line routing interconnects L1-Ln increases with an increase in the number rows, and therefore, the number of scan-line interconnects S1-Sn. In some implementations, where the display apparatus can include thousands of rows of display elements 306, the routing width W_{L} occupied by the scan-line routing interconnects L-Ln can be undesirably large. A large routing width W_{L} can result in a smaller area available for forming the display elements 306. A large routing width W_{L} also can undesirably result in a larger bezel for accommodating the scan-line routing interconnects L1-Ln.

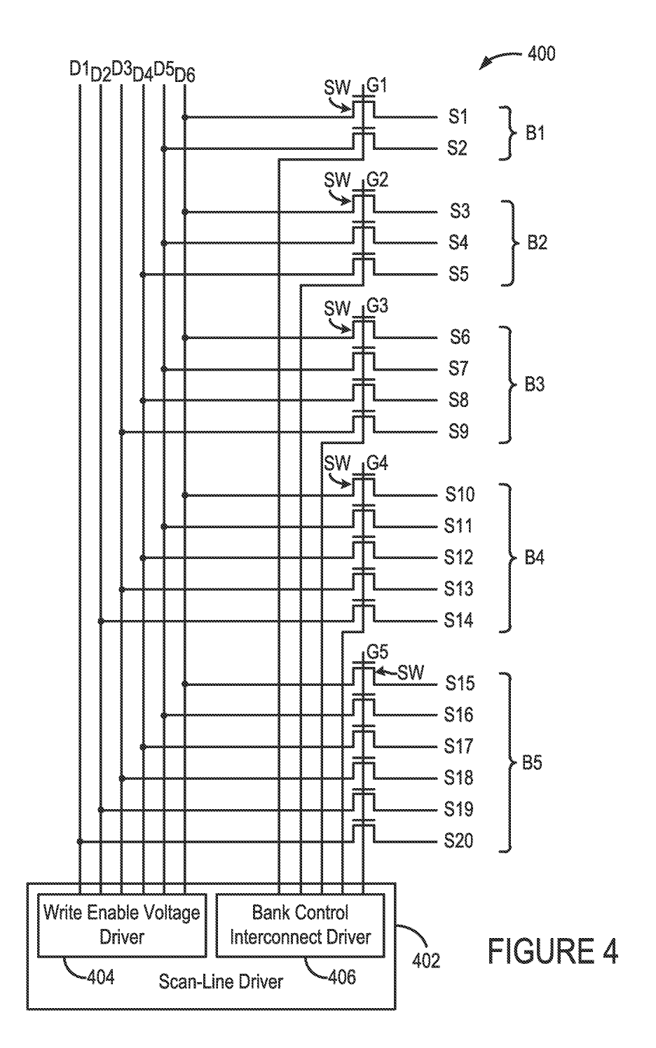

One approach to reducing the number of scan-line routing L1-Ln interconnects along the edge of the substrate, and thereby, reduce the bezel size, is to adopt an address selector architecture. Several example address selector architectures are discussed below with reference to FIGS. 4-7.

FIG. 4 shows an example address selector architecture 400. In particular, the address selector architecture 400 is capable of addressing a set of n rows of display elements, such as the n rows of display elements 306 shown in the display area 302 in FIG. 3. For example, the address selector architecture 400 shown in FIG. 4 can replace the scan-line routing interconnects L1-Ln shown in FIG. 3. As discussed below, utilizing the address selector architecture 400 for addressing scan-line interconnects S1-Sn can reduce the number of routing interconnects routed along the edge of the substrate (such as the substrate 304 shown in FIG. 3).

The example address selector architecture 400 shown in FIG. 4 is capable of providing write-enable voltages to twenty rows of display elements, where all display elements in a given row are coupled to a common scan-line interconnect. However, the number twenty has been used as an example, and in some implementations, the number of rows for which the address selector architecture 400 can provide write-enable voltages can be any number other than twenty, including up to more than 1000. Portions of the twenty scan-line interconnects S1-S20 are shown in FIG. 4. In addition to the scan-line interconnects S1-S20, the address selector architecture 400 includes six bank drive interconnects D1-D6. Each scan-line interconnect S1-S20 is selectively electrically connected to one bank drive interconnect D1-D6 via a switch SW. For example, scan-line interconnects S1 and S2 are selectively electrically connected to the bank drive interconnects D6 and D5, respectively; scan-line interconnects S3, S4, and S5 are selectively electrically connected to the bank drive interconnects D6, D5, and D4, respectively; scan-line interconnects S6, S7, S8, and S9 are selectively electrically connected to the bank drive interconnects D6, D5, D4 and D3, respectively; scan-line interconnects S10, S11, S12, S13 and S14 are selectively electrically connected to the bank drive interconnects D6, D5, D4, D3, and D2, respectively; and scan-line interconnects S15, S16, S17, S18, S19, and S20 are selectively electrically connected to the bank drive interconnects D6, D5, D4, D3, D2, and D1 respectively, via switches SW.

The scan-line interconnects S1-S20 can be grouped into banks of rows. For example, the scan-line interconnects S1-S20 are grouped into five row-banks B1-B5. Scan-line interconnects S1 and S2 are grouped into the row-bank B1, scan-line interconnects S3, S4, and S5 are grouped into the row-bank B2, scan-line interconnects S6, S7, S8, and S9 are grouped into the row-bank B3, scan-line interconnects S10, S1, S12, S13 and S14 are grouped into the row-bank B4, and scan-line interconnects S15, S16, S17, S18, S19, and S20 are grouped into the row-bank B5. The number of row-banks and the number of scan-line interconnects grouped within each row-bank can vary. In some implementations, as discussed further below, the number of row-banks and the number of scan-line interconnects grouped within each row-bank can be based, in part, on the total number of scan-line interconnects and the distances of the scan-line interconnects from the scan-line driver. In some implementations, the number of bank drive interconnects can be equal to the number of scan-line interconnects in the largest bank of rows. For example, the row-bank B5 includes the largest number, six, of scan-line interconnects (S15 to S20). Thus, the number of bank drive interconnects also can be equal to six. In some implementations, at least two of the row-banks can include the same number of scan-line interconnects.

Switches SW belonging to the same row-bank are controlled by a common bank control interconnect. For example, the gate terminals of all switches SW in the row-bank B1 are connected to the bank control interconnect G1. Similarly, the gate terminals of switches SW in the row-bank B2, B3, B4, and B5 are connected to bank control interconnects G2, G3, G4, and G5, respectively. All switches SW connected to the same bank control interconnect can be switched ON and OFF by applying a row-bank enable voltage of an appropriate level to their common bank control interconnect. In particular, a high row-bank enable voltage (such as about 0.5 V to about 5 V), when applied to a bank control interconnect can switch ON the switches SW in the respective row-bank, while applying a low row-bank enable voltage (such as about 0 V) to a bank control interconnect can switch OFF the switches. When the switches SW for a particular row-bank are switched ON, each of the scan-line interconnects of that row-bank is connected to one bank drive interconnect. For example, switching ON and OFF the switches SW of the row-bank B1 connects and disconnects, respectively, the scan-line interconnect S1 from the bank drive interconnect D6 and the scan-line interconnect S2 from the bank drive interconnect D5.

In some implementations, the switches SW can be implemented using transistors. In some such implementations, the switches SW can be implemented using thin-film-transistors (TFT). In some implementations, the TFTs can be formed using semiconductors such as amorphous-silicon (a-Si), indium-gallium-zinc-oxide (IGZO) or other conductive oxide semiconductors, poly-silicon, and low temperature poly-silicon (LTPS). In some implementations, the transistors can be formed using metal-oxide semiconductor field-effect transistors (MOSFETs). In some implementations, the switches can be formed over the substrate 304 shown in FIG. 3.

The bank drive interconnects D1-D6 and the bank control interconnects G1-G5 are coupled to a scan-line driver 402. The scan-line driver 402 includes a write enable voltage driver 404 and a bank control interconnect driver 406. The write enable voltage driver 404 provides write enable voltages to each of the bank drive interconnects D1-D6. The bank control interconnect driver 406 provides row-bank enable voltage to each of the bank control interconnects G1-G5. The write enable voltage driver 404 and the bank control interconnect driver 406 can control the timing and the magnitude of the write enable voltages and the row-bank enable voltages, respectively, to address each of the scan-line interconnects S1-S20.

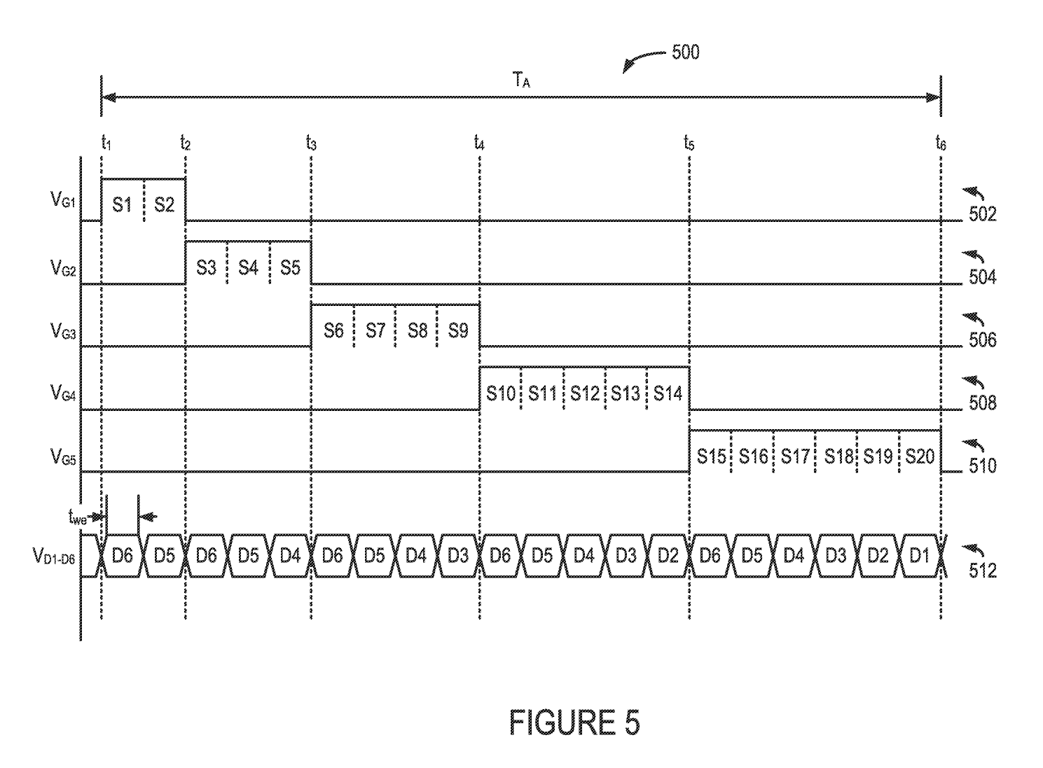

FIG. 5 shows an example timing diagram 500 for various signals output by the scan-line driver 402 shown in FIG. 4 during an addressing period. In particular, the timing diagram 500 shows the timing and magnitude of the write enable voltages and the row-bank enable voltages output by the write enable voltage driver 404 and the bank control interconnect driver 406 to provide write enabling signals to individual scan-line interconnects S1-S20 during an addressing period T_{A}. V_{G1} 502 represents the voltage at the bank control interconnect G1, V_{G2} 504 represents the voltage at the bank control interconnect G2, V_{G3} 506 represents the voltage at the bank control interconnect G3, V_{G4} 508 represents the voltage at the bank control interconnect G4, V_{G5} 510 represents the voltage at the bank control interconnect G5, and V_{D1-D6} 512 represents the voltages at the bank drive interconnects D1-D6. Specifically, V_{D1-D6} 512 indicates, at any given time, which one of the six bank drive interconnects D1-D6 is charged with a write enable voltage. The addressing period T_{A} forms a portion of the complete image frame period. For example, the complete image frame period, subsequent to the addressing period T_{A} can include one or more display element actuation periods and lamp illumination periods.

Each voltage shown in the timing diagram 500 generally swings between a high and a low value. However, the high and low values for any one voltage may or may not be equal to the high and low values for another voltage. The rise and fall times for various voltages and the durations between various events and transitions shown in the timing diagram 500 are merely for illustration, and may not represent the actual times or durations of voltages at various nodes and interconnects in the display apparatus 300. In some implementations, the voltages V_{G1}-V_{G5} can swing between a voltage that can turn the switch SW (shown in FIG. 4) sufficiently ON and a voltage that can turn the switch SW sufficiently OFF. In some implementations, where TFTs are utilized for implementing the switches SW, the voltages V_{G1}-V_{G5} can swing between a voltage that is below the threshold voltage of the TFT and a voltage that is substantially above the threshold voltage of the TFT. For example, in some implementations, where the threshold voltage of the TFT is about 0.5 V, the voltages V_{G1}-V_{G5} can swing between about 0 V to about 3 V. The voltages V_{D1-D6} also can swing between a high write enable voltage and a low write enable voltage. In some implementations, the voltages V_{D1-D6} can swing between voltage levels similar to those of the voltages V_{G1}-V_{G5} discussed above.

Referring to FIGS. 3-5, the addressing period T_{A} begins at time t₁ with the bank control interconnect driver 406 pulling the voltage V_{G1} 502 on the bank control interconnect G1 high. The voltages V_{G2} 504, V_{G3} 506, V₄ 508, and V_{G5} 510 are maintained low. As the bank control interconnect G1 is coupled to the gate terminals of all the switches SW within the row-bank B1, the switches SW coupled to the scan-line interconnects S and S2 are switched ON. As a result, the scan-line interconnects S and S2 are electrically connected to the bank drive interconnects D6 and D5, respectively. Also at time t₁, the write enable voltage driver 404 applies a high write enable voltage on the bank drive interconnect D6. As the bank drive interconnect D6 and the scan-line interconnect S1 are electrically connected via the switch SW, the scan-line interconnect S1 also charges to a voltage substantially equal to the high write enable voltage on the bank drive interconnect D6. As a result, each of the display elements coupled to the scan-line interconnect S1 are enabled to store the data voltage applied to their respective data interconnects (not shown).

After the elapse of a write enable period t_{we}, the write enable voltage driver 404 lowers the write enable voltage on the bank drive interconnect D6 and applies a high write enable voltage on the bank drive interconnect D5. The voltage V_{G1} 502 at the bank control interconnect G1 is maintained at a high voltage. As a result, the voltage on the scan-line interconnect S1 is pulled low, while the scan-line interconnect S2 is charged to a voltage that is substantially equal to the write enable voltage on the bank drive interconnect D5. As a result, each of the display elements coupled to the scan-line interconnect S2 are enabled to store the data voltage applied to their respective data interconnects (not shown). Again, after the elapse of a write enable period, the write enable voltage driver 404 lowers the write enable voltage on the bank drive interconnect D5. As the scan-line interconnect S2 is the last scan-line interconnect in the row-bank B1, the bank control interconnect driver 406 also lowers the voltage V_{G1} 502 on the bank control interconnect G1. This results in the switches SW in the row-bank B1 to switch OFF-disconnecting the scan-line interconnects S1 and S2 from the bank drive interconnects D6 and D5, respectively.

At time t₂, the scan-line driver 402 commences addressing scan-line interconnects in the row-bank B2. Specifically, the bank control interconnect driver 406 pulls the voltage V_{G2} 504 on the bank control interconnect G2 high, thereby switching ON the switches SW in the row-bank B2. The write enable voltage driver 404 can then apply a write enable voltage, one at a time, to each of the bank drive interconnects D6, D5, and D4 for a write enable period to provide write enable voltages to scan-line interconnects S3, S4, and S5, respectively. After the scan-line interconnect S5 has been provided with the write enable voltage for the write enable period, the bank control interconnect driver 406 pulls down the voltage V_{G2} 504 on the bank control interconnect G1, switching OFF the switches SW in the row-bank B2. As a result, the scan-line interconnects S3, S4, and S5 are disconnected from the bank drive interconnects D6, D5, and D4, respectively.

At time t₃, the scan-line driver 402 commences addressing scan-line interconnects in the row-bank B3. The bank control interconnect driver 406 pulls the voltage V_{G3} 506 on the bank control interconnect G3 high for the entire period for which the scan-line interconnect S6, S7, S8, and S9 are addressed. The write enable voltage driver 404 applies a high write enable voltage, one at a time, to each of the bank drive interconnects D6, D5, D4, and D3 to provide write enable voltages to scan-line interconnects S6, S7, S8, and S9, respectively.

At times t₄ and t₅ the scan-line driver 402, in a manner similar to that discussed above, provides write enabling voltages to scan-line interconnects in the row-banks B4 and B5, respectively. Specifically, starting at time t₄, the bank control interconnect driver 406 maintains a high voltage V_{G4} 508 on the bank control interconnect G4 for the entire period for which scan-line interconnects S10, S11, S13, S14, and S15 are sequentially provided with a write enable voltage. Similarly, at time t₅, the bank control interconnect driver 406 maintains a high voltage V_{G5} 510 on the bank control interconnect G5 for the entire period for which the scan-line interconnects S16, S17, S18, S19, and S20 are sequentially provided with a write enable voltage. At time t₆, the addressing period T_{A} ends, by which time data can be loaded in the display elements 306 in all the twenty rows.

As mentioned above, the address selector architecture 400 shown in FIG. 4 can reduce the routing width W_{L} needed along the edge of the substrate (such as the substrate 304 shown in FIG. 3). For example, referring to FIG. 3, if twenty scan-line routing interconnects L1-L20 were to be utilized to connect to twenty scan-line interconnects S1-S20 in the display apparatus 300, then each of the twenty scan-line routing interconnects L1-L20 would be routed along the edge of the substrate 304. However, the address selector architecture 400 shown in FIG. 4 uses six bank drive interconnects and five bank control interconnects (for a total of eleven interconnects) to be routed along the edge of the substrate 304 and some additional space to form the switches SW. Thus, utilizing the address selector architecture 400 can result in considerable reduction in the routing width W_{L} needed along the edge of the substrate 304, thereby providing a larger proportion of the area of the substrate that can be used as the display area and reducing the width of the bezel that would be needed to cover the bank drive interconnects. Further, the pin-count for an integrated circuit that includes the scan-line driver 402 shown in FIG. 4 is eleven, which is less than the pin-count of twenty for an integrated circuit that includes the scan-line driver 308 shown in FIG. 3.

Referring again to FIG. 4, in some implementations, the number of scan-line interconnects within each row-bank can be selected such that the signal propagation delay over the bank control interconnects G1-G5 is balanced. In some implementations, the signal propagation delay over the bank control interconnects G1-G5 is balanced to the point of being substantially equal. The signal propagation delay over the bank control interconnects can be based in part on the load seen by the bank control interconnect driver over each of the bank control interconnects G1-G5. In some implementations, by balancing the load across the bank control interconnects G1-G5, the propagation delay over the bank control interconnects G1-G5 also can be balanced. The load seen by the bank control interconnect driver 406 over each of the bank control interconnects G1-G5, in turn, can be a function, in part, of the length of the bank control interconnect and the number of switches SW coupled to the bank control interconnect. For example, the gate terminal capacitance of the TFTs utilized for implementing the switches SW can contribute to the load associated with a bank control interconnect. That is, the load increases with an increase in the number of switches SW coupled to the bank control interconnect. Further, the resistance and capacitance of the bank control interconnect, as a function of its length, also can contribute to the load. That is, the load increases with the length of the bank control interconnect. In some implementations, the capacitance of the bank control interconnect can be relatively small in magnitude. In such implementations, the load associated with the bank control interconnect can be represented by product of the resistance of the bank control interconnect and the total capacitance resulting from the gate terminals of the switches SW connected to the bank control interconnect.

To balance the loads over the bank control interconnects G1-G5, the length of the bank control interconnect can be balanced with the number of switches SW coupled to the bank control interconnect. For example, as shown in FIG. 4, the bank control interconnect G1, which has the greatest length, is coupled to the gate terminals of two switches SW; the bank control interconnect G2, which has the next greatest length, is coupled to the gate terminals of three switches SW, and so on. As a result, the RC load associated with the bank control interconnects G1-G5 can be substantially equal.

In some implementations, the total delay in addressing the scan-lines can be a function of the longest propagation delay of a signal in the address selector architecture. For example, consider an address selector architecture, similar to the address selector architecture 400 shown in FIG. 4, but in which the number of scan-line interconnects within each bank are the same. That is, each of the banks B1-B5 include 4 scan-line interconnects. Thus, each of the bank control interconnects G1-G5 would be connected to the gate terminals of four switches SW. As a result, the capacitive load due to the gate terminals of the switches SW on each of the bank control interconnects G1-G5 would be substantially the same. However, the lengths of the bank control interconnects G1-G5 are unequal, and, therefore, the resistive load due to their lengths (and the resulting propagation delay of the signals carried by the interconnects) would also be unequal. For example, the bank control interconnect G5 is the shortest (having least resistance) while the bank control interconnect G1 is the longest (having the greatest resistance) among the bank control interconnects G1-G5. In some implementations, the propagation delay of a signal over an interconnect can be a direct function of the product of the resistance of the interconnect and the capacitance connected to the interconnect, also referred to as the RC load or the RC time constant. Thus, among two interconnects with different RC loads associated with them, the one having the larger RC load will have a greater signal propagation delay. Referring again to the bank control interconnects G1-G5, as the capacitive load on each of the bank control interconnects is substantially the same, the RC load associated with each of the bank control interconnects is a function of their respective resistances. That is, among the bank control interconnects G1-G5, the bank control interconnect G5 has the least RC time constant, while the bank control interconnect G1 has the greatest RC time constant. As a result, the propagation delay of a bank control signal over the bank control interconnect G5 would be the shortest while the propagation delay of the bank control signal over the bank control interconnect G1 would be the longest. Thus, if the propagation delay of the bank control signal over the bank control interconnect G1 were to be the longest propagation delay within the address selector architecture, then this propagation delay would directly affect the total delay in addressing the scan-lines.

In some implementations, balancing the load on the bank control interconnects G1-G5 can reduce the longest propagation delay over the bank control interconnects. In some implementations, as in the address selector architecture 400 shown in FIG. 4, the load on the bank control interconnects G1-G5 can be balanced by distributing the capacitive and resistive load over the bank control interconnects such that the RC loads associated with each bank control interconnect is substantially the same. In particular, the capacitive load due to the gate terminals of the switches can be distributed among the bank control interconnects G1-G5 based on their individual resistances. For example, reducing the number of switches SW connected to the longest bank control interconnect G1, which has the highest resistance among the bank control interconnects G1-G5, can reduce the overall capacitance load, and in turn the RC load, associated with the bank control interconnect G1. Further, increasing the number of switches SW connected to the shortest bank control interconnect G5 can increase the RC load associated with the bank control interconnect G5. The RC loads associated with the remainder of the bank control interconnects can be similarly adjusted. One example of distributing the RC load on the bank control interconnects is shown in the example address selector architecture 400 shown in FIG. 4, and has been described above. In some implementations, the smallest possible propagation delay among all the bank control interconnects G1-G5 can be obtained when the total RC load on each of the bank control interconnects G1-G5 is substantially equal.

Balancing the load, and therefore the propagation delays, over the bank control interconnects G1-G5 also can help ensure that the relative timing of various signals are appropriately aligned. For example, having balanced propagation delays on all the bank control interconnects G1-G5 can help ensure that the timing of the voltages V_{G1}-V_{G5} 502-510 are appropriately aligned with the timing of the write enable signals V_{D1-D6} 512.

Further, aligning the relative timing of various signals by load balancing can alleviate the need for otherwise intentionally introducing delays (by using, for example, delay lines) to align the timing of the various signals. Avoiding the introduction of delays can further reduce the overall propagation time of various signals. In some implementations, a reduction in the overall propagation time can allow displaying subframes for longer periods with corresponding reduction in light source intensity. The reduction in the intensity of the light sources can result in the reduction in the overall power consumption of the display apparatus.

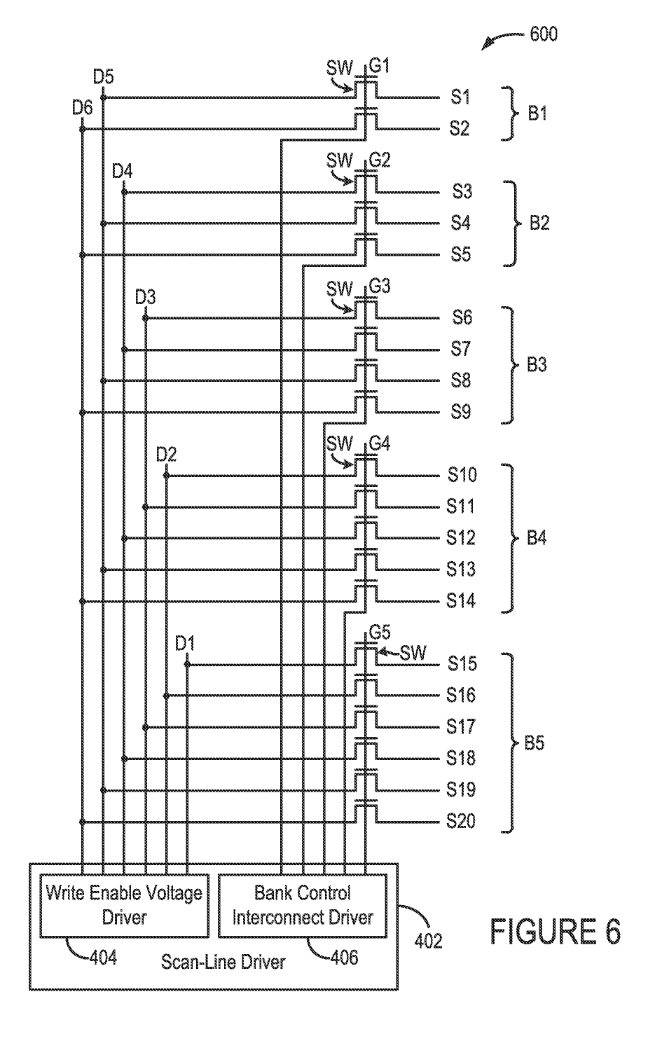

FIG. 6 shows another example address selector architecture 600. In particular, the address selector architecture 600 is capable of addressing a set of rows of display elements, such as the display elements 306 shown in the display area 302 in FIG. 3. For example, the address selector architecture 600 shown in FIG. 6 can replace the scan-line interconnects S1-Sn shown in FIG. 3. The address selector architecture 600 shown in FIG. 6 is similar to the address selector architecture 400 shown in FIG. 4; however, in the address selector architecture 600 the bank drive interconnects D1-D6 are arranged in a manner to reduce the area occupied by the bank drive interconnects D1-D6. In some implementations, the additional area available can be utilized for increasing the sizes of the TFTs utilized for implementing the switches SW.

The length of any given bank drive interconnect in the address selector architecture 600 is terminated at the farthest switch SW (from the scan-line driver 402) to which the bank drive interconnect is be connected. For example, a switch SW coupled to the scan-line interconnect S15 in the row-bank B5 is the farthest switch SW to which the bank drive interconnect D1 is connected. Thus, the bank drive interconnect D1 is terminated at the farthest switch in the row-bank B5. Similarly, the bank drive interconnect D2 is terminated at the switch coupled to the scan-line interconnect S10 in the row-bank B4, the bank drive interconnect D3 is terminated at the switch SW coupled to the scan-line interconnect S6 in the row-bank B3, the bank drive interconnect D4 is terminated at the switch SW coupled to the scan-line interconnect S3 in the row-bank B2, and the bank drive interconnects D5 and D6 are terminated at the switches SW coupled to the scan-line interconnects S1 and S2, respectively, in the row-bank B1.

As mentioned above, in some implementations, the additional area made available due to the termination of one or more bank drive interconnects D1-D6 can be utilized for increasing the sizes of the TFTs used for implementing the switches SW. In some implementations, increasing the sizes of the TFTs can increase the current carrying capacity of the TFTs. Increasing the current carrying capacity of the TFT can, in turn, reduce the propagation delay of the write enable signal provided to the scan-line interconnects S1-S20 through the TFTs. In some implementations, the sizes of the TFTs can be increased as a function of their distance from the scan-line driver 402. For example, the sizes of the TFTs within the farthest row-bank B1 can be larger than the TFTs within the next to the farthest row-bank B2. Increasing the sizes of the TFTs in the farthest row-banks can reduce the propagation delay of the write enable signals to those row-banks. In some implementations, propagation delay of the write-enable signals over the bank drive interconnects D1-D6, the switches SW, and the scan-line interconnects S1-S20 also can contribute to the total delay in addressing the display elements. Therefore, reducing the propagation time of the write-enable signals over the bank drive interconnects D1-D6 and the switches SW can reduce the total delay in addressing the display elements.

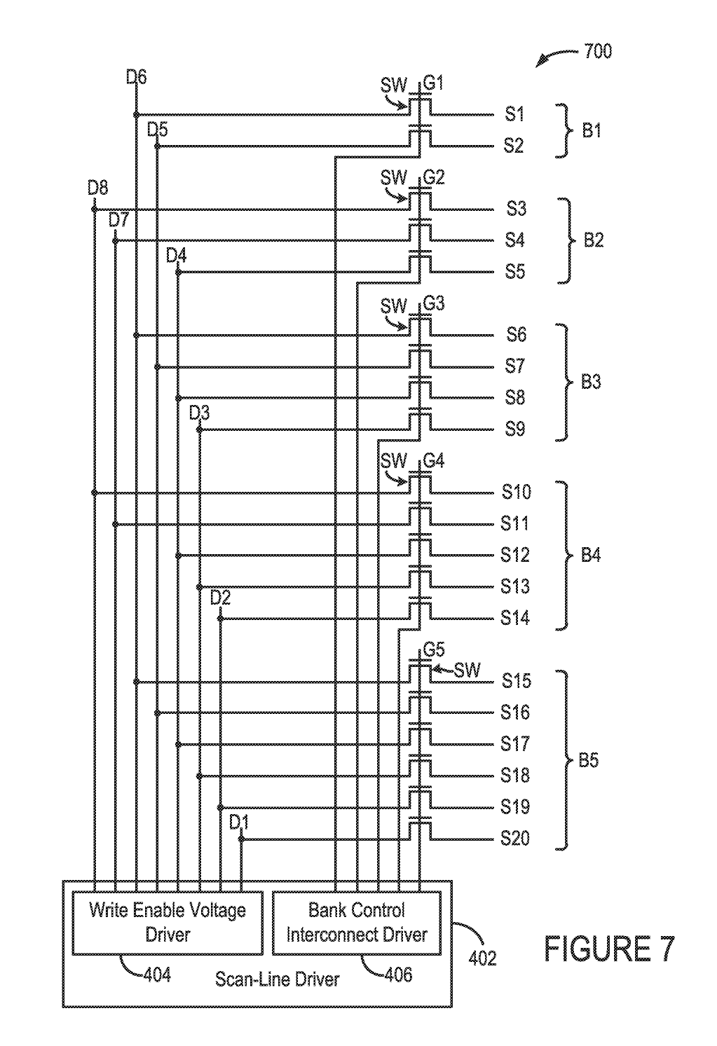

FIG. 7 shows another example address selector architecture 700. In particular, the address selector architecture 700 is capable of addressing a set of rows of display elements, such as the display elements 306 shown in the display area 302 in FIG. 3. For example, the address selector architecture 700 shown in FIG. 7 can replace the scan-line routing interconnects L1-Ln shown in FIG. 3. The address selector architecture 700 shown in FIG. 7 is similar to the address selector architecture 600 shown in FIG. 6, in that the address selector architecture 700 also includes reduced length bank drive interconnects. However, the address selector architecture 700 includes a different number and configuration of the bank drive interconnects to balance the loads on the bank drive interconnects in addition to balancing the loads on the bank control interconnects G1-G5 (as was done in the address selector architecture 400 shown in FIG. 4). In some implementations, balancing the loads on the bank drive interconnects can ensure that scan-line interconnects farthest from the scan-line driver 402 are not driven by heavier loaded bank drive interconnects.

Compared to the address selector architecture 600 shown in FIG. 6, the address selector architecture 700 includes two additional bank drive interconnects D7 and D8. The scan-line interconnects S1 and S2 are selectively electrically connected to the bank drive interconnects D6 and D5, respectively; scan-line interconnects S3, S4, and S5 are selectively electrically connected to the bank drive interconnects D8, D7, and D4, respectively; scan-line interconnects S6, S7, S8, and S9 are selectively electrically connected to the bank drive interconnects D6, D5, D4 and D3, respectively; scan-line interconnects S10, S11, S12, S13 and S14 are selectively electrically connected to the bank drive interconnects D5, D7, D4, D3, and D2, respectively; and scan-line interconnects S15, S16, S17, S18, S19, and S20 are selectively electrically connected to the bank drive interconnects D6, D5, D4, D3, D2, and D1, respectively, via switches SW.

The load (for example, the RC load) on each of the bank drive interconnects D1-D8 is, in part, a function of the length of the bank drive interconnect and the number of switches SW coupled to the bank drive interconnect. Referring again to the address selector architecture 600 shown in FIG. 6, the bank drive interconnect D6 is the longest of all the bank drive interconnects D1-D6 and is connected to the greatest number of switches SW. As a result, the load seen by the write enable voltage driver 404 for the bank drive interconnect D6 is greater than that seen for all other bank drive interconnects. This load imbalance can lead to propagation delays on the bank drive interconnect D6 that are greater than propagation delays on other bank drive interconnects. The address selector architecture 700 utilizes the additional bank drive interconnects D7 and D8 to distribute the number of switches connected to each bank drive interconnect and can help balance the load on the bank drive interconnects D1-D8. For example, the bank drive interconnect D6 is connected to three switches SW associated with the scan-line interconnects S1, S6, and S15, instead of being connected to five switches SW as shown in the address selector architecture 600 shown in FIG. 6. Thus, the propagation delay of the write enable signal applied by the write enable voltage driver 404 to the bank drive interconnect D6 is reduced due to the reduced load. Similarly, by substantially balancing the loads on the bank drive interconnects D1-D8, the propagation delays of the write enable signals on the bank drive interconnects D1-D8 can be balanced.

Balancing the propagation delays on the bank drive interconnects D1-D8 can result in the reduction in the overall propagation delays on the bank drive interconnects and also allow a reduction in the overall power consumption of the display apparatus.

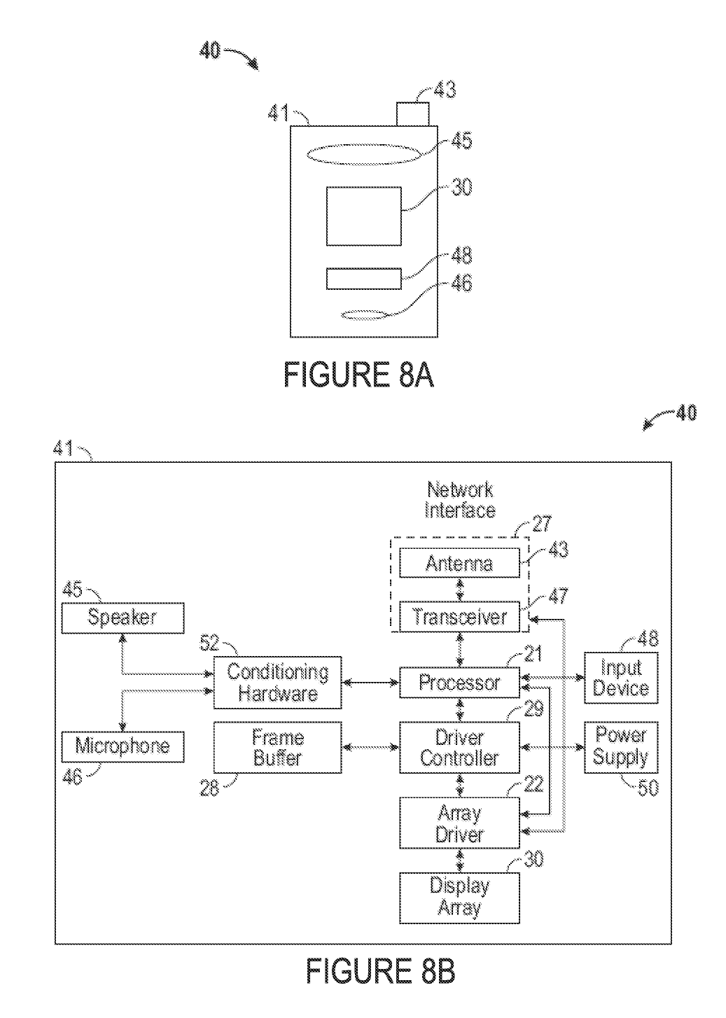

FIGS. 8A and 8B show system block diagrams of an example display device 40 that includes a plurality of display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be capable of including a flat-panel display, such as plasma, electroluminescent (EL) displays, OLED, super twisted nematic (STN) display, LCD, or thin-film transistor (TFT) LCD, or a non-flat-panel display, such as a cathode ray tube (CRT) or other tube device. In addition, the display 30 can include a mechanical light modulator-based display, as described herein.

The components of the display device 40 are schematically illustrated in FIG. 8B. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 8A, can be capable of functioning as a memory device and be capable of communicating with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to any of the IEEE 16.11 standards, or any of the IEEE 802.11 standards. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B. High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G, or further implementations thereof, technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller. CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29 is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements. In some implementations, the array driver 22 and the display array 30 are a part of a display module. In some implementations, the driver controller 29, the array driver 22, and the display array 30 are a part of the display module.

In some implementations, the driver controller 29, the array driver 22, and the display array 30 are appropriate for any of the types of displays described herein. For example, the driver controller 29 can be a conventional display controller or a bi-stable display controller (such as a mechanical light modulator display element controller). Additionally, the array driver 22 can be a conventional driver or a bi-stable display driver (such as a mechanical light modulator display element controller). Moreover, the display array 30 can be a conventional display array or a bi-stable display array (such as a display including an array of mechanical light modulator display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40. Additionally, in some implementations, voice commands can be used for controlling display parameters and settings.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs. i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus comprising:
an array of display elements arranged in rows and columns;
a plurality of scan-line interconnects arranged in row-banks, each of the plurality of scan-line interconnects coupled to one row of display elements;
a plurality of bank drive interconnects, each of the plurality of bank drive interconnects capable of carrying a write enable voltage to one scan-line interconnect in at least one row-bank;
a write enable voltage driver coupled to the plurality of bank drive interconnects and capable of providing write enable voltages to each of the plurality of bank drive interconnects;
a plurality of row-enable transistors, wherein one of the source and drain terminals of each of the plurality of row-enable transistors is coupled to one of the plurality of scan-line interconnects, and the other terminal is coupled to one of the plurality of bank drive interconnects;
a plurality of bank control interconnects, each of the plurality of bank control interconnects coupled to the gate terminals of the row-enable transistors associated with scan-line interconnects of a corresponding row-bank; and
a bank control interconnect driver coupled to the plurality of bank control interconnects capable of providing control voltages to each of the plurality of bank control interconnects;
wherein the number of scan-line interconnects in a first row-bank located a first distance from the write-enable voltage driver is greater than a number of scan-line interconnects in a second row-bank of scan-line interconnects located a second distance, farther from the write-enable voltage driver.

2. The apparatus of claim 1, wherein the number of scan-line interconnects in each row-bank is based in part on a load parameter associated with a bank control interconnect coupled to the row-enable transistors associated with the respective row-banks.

3. The apparatus of claim 1, wherein the size of a first of the row-enable transistors located a first distance from the bank control interconnect driver is greater than the size of a second of the row-enable transistors located a second distance, nearer from the bank control interconnect driver.

4. The apparatus of claim 1, wherein the sizes of the plurality of row-enable transistors are substantially the same.

5. The apparatus of claim 1, wherein the row-enable transistor located farthest from the write-enable voltage driver is coupled to a bank drive interconnect that is coupled to a fewer number of other row-enable transistors than at least one other bank drive interconnect.

6. The apparatus of claim 1, wherein propagation delays of control voltages provided by the bank control interconnect driver over the plurality of bank control interconnects are substantially equal.

7. The apparatus of claim 1, wherein the number of bank drive interconnects is equal to the number of row-enable transistors in the largest row-bank of scan-line interconnects.

8. The apparatus of claim 1, wherein each of the bank drive interconnects terminates at the farthest row-enable transistor coupled to the bank drive interconnect.

9. The apparatus of claim 1, wherein the array of display elements are located within a display area on a substrate, and wherein the plurality of bank drive interconnects and the plurality of bank control interconnects are located on the substrate outside of the display area.

10. The apparatus of claim 1, wherein RC time constants associated with the plurality of row-control interconnect are substantially equal.

11. The apparatus of claim 1, further comprising:
a display;
a processor capable of communicating with the display, the processor being capable of processing image data; and
a memory device capable of communicating with the processor.

12. The apparatus of claim 11, further comprising:
a driver circuit capable of sending at least one signal to the display; and
a controller capable of sending at least a portion of the image data to the driver circuit.

13. The apparatus of claim 11, further comprising:
an image source module capable of sending the image data to the processor, wherein the image source module includes at least one of a receiver, transceiver, and transmitter.

14. The apparatus of claim 11, further comprising:
an input device capable of receiving input data and communicating the input data to the processor.

15. An apparatus comprising:
an array of display elements arranged in rows and columns;
a plurality of scan-line interconnects arranged in row-banks, each of the plurality of scan-line interconnects coupled to one row of display elements from the array of display elements;
a plurality of bank drive interconnects, each of the plurality of bank drive interconnects capable of carrying a write enable voltage to one scan-line interconnect in at least one row-bank;
a write enable voltage driver coupled to the plurality of bank drive interconnects and capable of providing write enable voltages to each of the plurality of bank drive interconnects;
a plurality of row-enable transistors, wherein one of the source and drain terminals of each of the plurality of row-enable transistors is coupled to one of the plurality of scan-line interconnects, and the other of the source and drain terminals of each of the plurality of row-enable transistors is coupled to one of the plurality of bank drive interconnects;
a plurality of bank control interconnects, each of the plurality of bank control interconnects coupled to the gate terminals of the row-enable transistors associated with scan-line interconnects arranged in a corresponding row-bank; and
a bank control interconnect driver coupled to the plurality of bank control interconnects capable of providing control voltages to each of the plurality of bank control interconnects;
wherein the size of a first of the row-enable transistors located a first distance from the bank control interconnect driver is greater than the size of a second of the row-enable transistors located a second distance, nearer from the bank control interconnect driver.

16. The apparatus of claim 15, wherein the number of scan-line interconnects in a first row-bank located a first distance from the write-enable voltage driver is greater than a number of scan-line interconnects in a second row-bank of scan-line interconnects located a second distance, greater than the first distance, from the write-enable voltage driver.

17. The apparatus of claim 15, wherein each of the bank drive interconnects terminates at the farthest row-enable transistor coupled to the bank drive interconnect.

18. An apparatus comprising:
an array of display elements arranged in rows and columns;
a plurality of scan-line interconnects arranged in row-banks, each of the plurality of scan-line interconnects coupled to one row of display elements from the array of display elements;
a plurality of bank drive interconnects, each of the plurality of bank drive interconnects capable of carrying a write enable voltage to one scan-line interconnect in at least one row-bank;
a write enable voltage driver coupled to the plurality of bank drive interconnects and capable of providing write enable voltages to each of the plurality of bank drive interconnects;
a plurality of row-enable transistors, wherein one of the source and drain terminals of each of the plurality of row-enable transistors is coupled to one of the plurality of scan-line interconnects, and the other of the source and drain terminals of each of the plurality of row-enable transistors is coupled to one of the plurality of bank drive interconnects;
a plurality of bank control interconnects, each of the plurality of bank control interconnects coupled to the gate terminals of the row-enable transistors associated with the scan-line interconnects of a corresponding row-bank; and
a bank control interconnect driver coupled to the plurality of bank control interconnects capable of providing control voltages to each of the plurality of bank control interconnects;
wherein each of the bank drive interconnects terminates at the farthest row-enable transistor coupled to the bank drive interconnect.

19. The apparatus of claim 18, wherein the number of scan-line interconnects in a first row-bank located a first distance from the write-enable voltage driver is greater than a number of scan-line interconnects in a second row-bank of scan-line interconnects located a second distance, greater than the first distance, from the write-enable voltage driver.

20. The apparatus of claim 18, wherein the size of a first of the row-enable transistors located a first distance from the bank control interconnect driver is greater than the size of a second of the row-enable transistors located a second distance from the bank control interconnect driver, wherein the first distance is greater than the second distance.
